(19) United States
(12) Patent Application Publication
(10) Pub. No.: US 2015/0371307 A1
(43) Pub. Date: Dec. 24, 2015

(54) Method For Wirelessly Generating Simulated Handwritten Correspondence

(71) Applicant: David Wachs, Chicago, IL (US)

(72) Inventor: David Wachs, Chicago, IL (US)

(73) Assignee: Handwrytten LLC, Los Angeles, CA (US)

(21) Appl. No.: 14/307,738

(22) Filed: Jun. 18, 2014

(51) Int. Cl. G06Q 30/06; H04L 29/08

(52) U.S. Cl. CPC G06Q 30/0621; H04L 67/10

(57) ABSTRACT

A system and method for generating simulated handwritten correspondence. The system allows the user to select a desired stationery from a plurality of available stationery; upload a custom photograph to be used in connection with the desired stationery (i.e., creating a photo postcard), if desired; select a handwriting style from a plurality of available handwriting styles which includes cursive and block styles, and varying or different pen types; enter the desired text or message to be written in the selected handwriting style on the desired stationery, and then process payment. At that point, the system proceeds to write the desired text or message into the selected handwriting style with the appropriate strokes and ligatures for translation onto the desired stationery paper using a writing machine.

### I. FIELD OF THE INVENTION

The present invention relates to signed correspondence and, more particularly, to a unique method for generating simulated handwritten correspondence.

### II. DESCRIPTION AND BACKGROUND OF THE INVENTION

In today's world, there exist many different devices and/or apparatus for producing a writing. For example, such devices or apparatus include but are not limited to, and in no particular order, those disclosed in U.S. Pat. No. 6,425,185 entitled “Machine For Reproducing Writing”; U.S. Patent Application, Serial Number 2012/0206758 entitled “Method, System and Computer Program For Generating Authenticated Documents”; and U.S. Patent Application, Serial Number 2009/0255137 entitled “Apparatus, System and Computer Program For Controlling A Tool.” Additionally, there are also many different systems for producing a writing for different applications such as in, and again in no particular order, U.S. Pat. No. 5,552,994 entitled “System For Printing Social Expression Cards In Response To Electrically Transmitted Orders”; U.S. Patent Application, Serial Number 2001/0048436 entitled “Method And Apparatus For Sending Electronic Mail Using Human Handwriting”; U.S. Patent Application, Serial Number 2004/0061888 entitled “Method And System For Creating And Sending A Facsimile Using A Digital Pen”; U.S. Pat. No. 8,064,702 entitled “Handwriting Templates”; U.S. Patent Application, Serial Number 2012/0001921 entitled “System And Method For Creating, Managing, Sharing And Displaying Personalized Fonts On A Client-Server Architecture”; and U.S. Patent Application, Serial Number 2005/0102620 entitled “Boxed And Lined Input Panel.” Although each of these different devices, apparatus, and/or systems for producing a writing may be useful for their particular applications, none of these address or disclose a system and method for generating simulated handwritten correspondence as invented by the Applicant.

Thus, there is a need and there has never been disclosed Applicant's unique system and method for generating handwritten signed correspondence.

### III. SUMMARY OF THE INVENTION

The present invention is a system and method for generating simulated handwritten correspondence. The system allows the user to select a desired stationery from a plurality of available stationery; upload a custom photograph to be used in connection with the desired stationery (i.e., creating a photo postcard), if desired; select a handwriting style from a plurality of available handwriting styles which includes cursive and block styles, and varying or different pen types; enter the desired text or message to be written in the selected handwriting style on the desired stationery, and then process payment. At that point, the system proceeds to write the desired text or message into the selected handwriting style with the appropriate strokes and ligatures for translation onto the desired stationery paper using a writing machine.

### IV. BRIEF DESCRIPTION OF THE DRAWINGS

The Description of the Preferred Embodiment will be better understood with reference to the following figures:

FIG. 1 is a diagram illustrating the computer hardware used in Applicant's system.

FIG. 2 is a flowchart illustrating the basic operation of Applicant's computer software system.

FIG. 3 is a diagram of the login interface screen for the computer software system.

FIG. 4 is a diagram of the inventory selection interface screen for the computer software system.

FIG. 5 is a diagram of the card detail view interface screen for the computer software system.

FIG. 6 is a diagram of the card composition interface screen for the computer software system.

FIG. 7 is a diagram of the return address interface screen for the computer software system.

FIG. 8 is a diagram of the existing return address interface screen for the computer software system.

FIG. 9 is a diagram of the delivery address interface screen for the computer software system.

FIG. 10 is a diagram of the billing information interface screen for the computer software system.

FIG. 11 is a diagram of the completed billing information interface screen for the computer software system.

FIG. 12 is a diagram of the update desired credit card interface screen for the computer software system.

FIG. 13 is a diagram of the order confirmation interface screen for the computer software system.

FIG. 14 is a diagram of the work order queue interface screen for the computer software system.

FIG. 15 is a diagram of the view work order interface screen for the computer software system.

FIG. 16 is a diagram of the envelope for the completed work order.

FIG. 17 is a diagram of the exterior of the printed card for the completed work order.

FIG. 18 is a diagram of the interior of the printed card for the completed work order.

### V. DETAILED DESCRIPTION OF THE PREFERRED EMBODIMENT

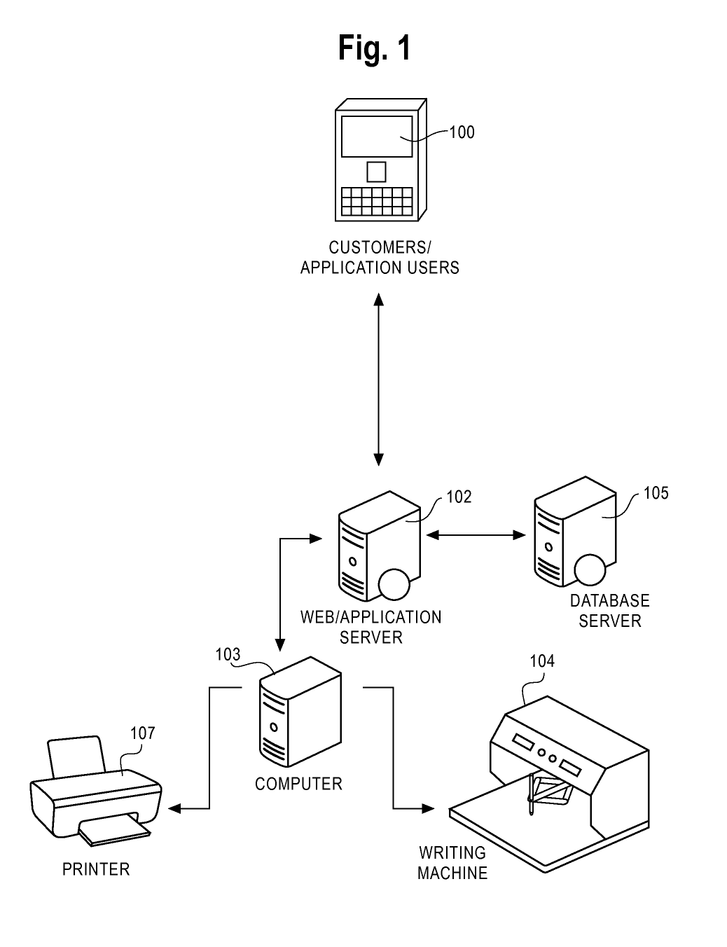

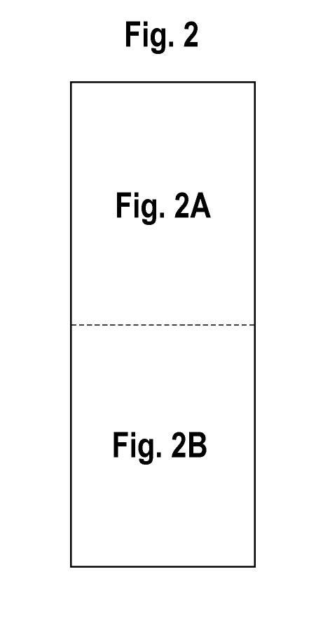

Applicant's invention consists of the interaction between computer hardware, as illustrated in FIG. 1, and computer software (“system”), as illustrated in FIG. 2.

Turning to FIG. 1, the computer hardware consists of a wireless communication device 100, a web/application server 102, a computer 103, a database server 105, a printer 107, and a writing machine 104.

In the preferred embodiment, the wireless communication device 100 is a mobile cellular telephone, a hand-held mobile tablet computer, and/or any other type of wireless communication device that is known to one skilled in the art which may be employed, used, or adapted for use with Applicant's invention.

The wireless communication device 100 is used to interface with the web application on the web/application server 102. The wireless communication device 100 runs a native application custom designed for this embodiment, and transfers instruction to the application server using one of a plurality of web service protocols, preferably JavaScript Object Notation (JSON) or Simple Object Access Protocol (SOAP). The native application is written in the native language for the specific wireless communication device 100, as dictated by the developer of the specific operating system. In the preferred embodiment, the iPhone implementation is written in Objective-C. The Android and Blackberry implementations are written in Java, and the Windows Phone implementation is written in a .NET language, such as C# or Visual Basic.NET.

The web/application server 102 is used to host a web application and a web service. The web application interfaces with a relational database server 105 to store, manage, and/or retrieve any or all communications, information, and/or data for the system. The web application also provides a web-based interface to manage the unfulfilled orders needed to be transcribed using the writing machine 104. The web/application server 102 is constantly running to facilitate all communication between the native application on the wireless communication device 100 and the other tether devices, processing and analyzing the communications received by the wireless and tethered devices, and appropriately reacting to the analysis of the communications received by the wireless and tethered devices. For example, the web/application server 102 interfaces with the database server 105 to send and receive communications and interfaces with the relational database to store and retrieve data. Preferably, the web/application server 102 uses a Linux variant operating system and an application written in PHP or Java.

Alternatively, any means known to one skilled in the art may be used for interfacing the wireless communication device 100 and the web/application server 102 provided that this means is used in the same manner to accomplish Applicant's invention.

The computer 103 is any modern computer capable of connecting to the web/application server 102 through the Internet and using a web browser and interfacing with the writing machine 104 via a driver and necessary interface cable or wireless communication. In this embodiment, the computer is preferably Windows 8 and runs any modern browser, such as Mozilla Firefox. The computer 103 also has the writing machine 104 driver installed. The printer 107 is preferably a color printer for printing on card stock and is compatible to and interfaces with the computer 103. Alternatively, the printer 107 may be any color printer known to one skilled in the art to accomplish Applicant's invention.

The database server 105 is used to host any modern relational database server. Preferably, the database server 105 uses a Linux variant operating system and MySQL-based database engine. Alternatively, the functions provided by the web/application server 102 and the database server 105 may be accomplished using the same server.

The writing machine 104 is preferably a writing machine device used for the automatic writing of a font using a pen such as, in a non-limiting example, the Ghostwriter® autopen products and/or any other autopen products manufactured by Automated Signature Technology located in Sterling, Va. Alternatively, the writing machine 104 may include any other type of writing machine device that is known to one skilled in the art which may be employed, used, or adapted for use with Applicant's invention.

Also, computer hardware and their components are well known in the art and it is contemplated that any compatible type, version, or size made by any manufacturer and applicable software for the computer hardware to interface or communicate with one another is acceptable to accomplish the intended purposes of Applicant's invention.

Turning to FIG. 2, there is illustrated a schematic diagram of the basic operation of a unique method for generating handwritten signed correspondence (“system 105”).

In Step 106, the process for generating simulated handwritten correspondence is illustrated. If a user desires to begin the process for generating simulated handwritten correspondence, proceed to Step 108. In the preferred embodiment, the user is any person that desires to use this system 105 (all such persons hereinafter referred to as “user”).

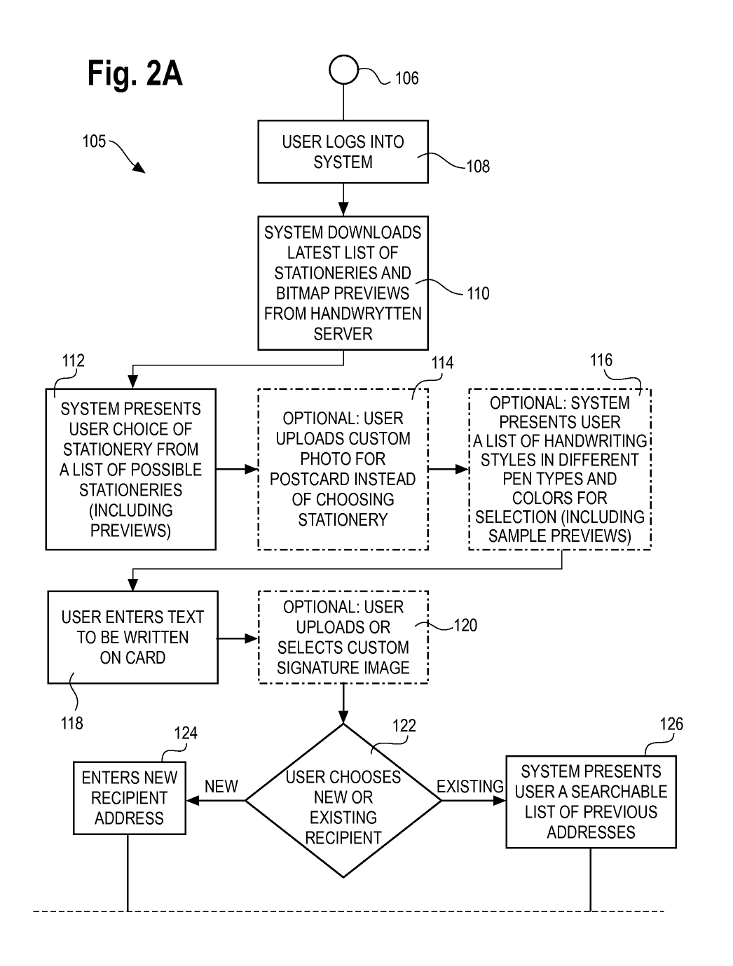

In Step 108, to access, enter, or otherwise log into the system 105, the user runs the native application custom designed for this system 105 from the wireless communication device 100. In the preferred embodiment, the system 105 displays a login interface 150, as illustrated in FIG. 3. The login interface 150 provides an email prompt 152, a password prompt 154, a log in button 156, and an account registration button 158.

The user enters into the email prompt 152 a unique electronic mail identification for the user, serving as their username, and enters into the password prompt 154 a unique password identification that is maintained in secret and known only to the user for accessing the system 105. Upon entering the correct combination of email into the email prompt 152 and password into the password prompt 154 and then clicking on or selecting the login button 156 will allow the user to gain access into the system 105.

In the preferred embodiment, the user selects the login button 156 by using their finger and clicking on the login button 156 within the login interface screen 150. For the avoidance of doubt and throughout this specification, “clicking”, or “selecting” is accomplished using the finger and engaging or depressing the finger on the desired button within the appropriate interface screen.

Alternatively, it is contemplated that the selection of the login button 156 may be accomplished using selection menu or buttons from the wireless communication device 100, a computer mouse (not illustrated), or in any other manner or means that is known to one skilled in the art.

If the user does not have or has not established an account in the system 105, clicking or selecting the account registration button 158 will proceed to allow the user to establish an account with these parameters.

When completed and successfully logged into the system 105, proceed to Step 110. In Step 110, upon successfully logging into the system 105, the system 105 downloads from the web/application server 102 to the wireless communication device 100 a plurality of available stationery and bitmap photograph previews corresponding to each of the plurality of available stationery residing on the database server 105. The system 105 then proceeds to Step 112.

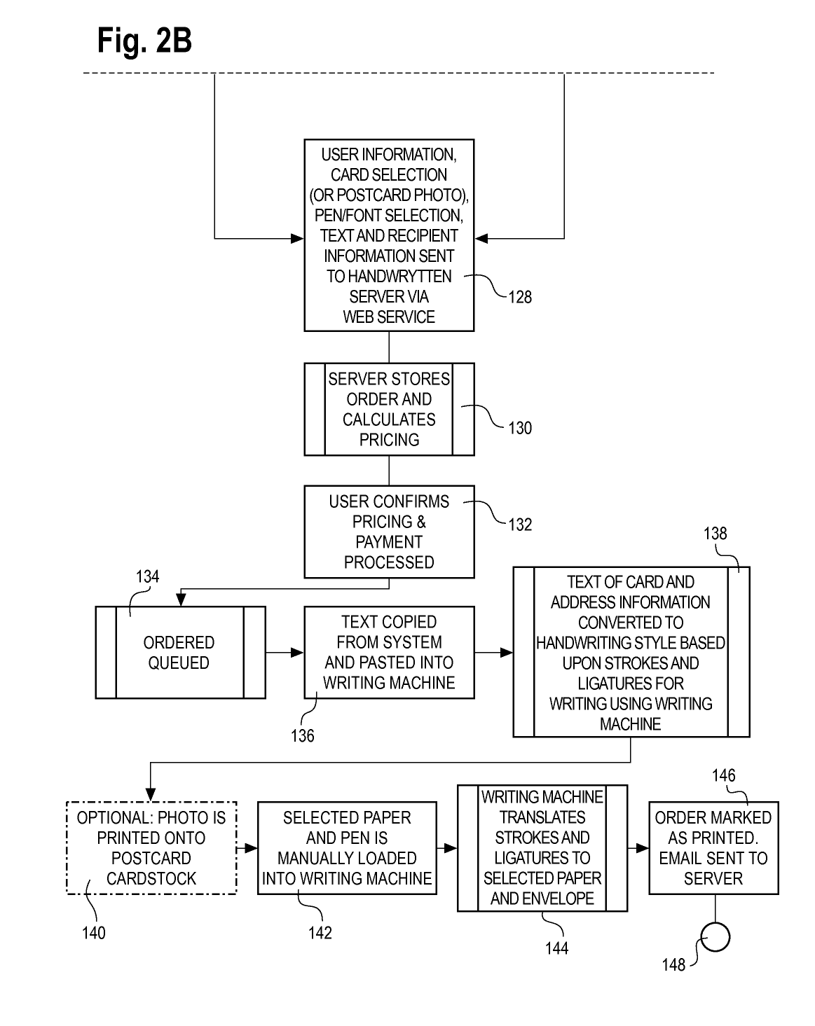

In Step 112, the system 105 displays an inventory selection interface screen 160, as illustrated in FIG. 4. The inventory selection interface screen 160 provides the plurality of available stationery 162 (also individually referred to as “stationery 162”) and the bitmap photograph previews 164 corresponding to each of the plurality of available stationery 162, which were downloaded in the previous Step 110. Each of the plurality of available stationery 162 is also provided with a card title 166. The prices 161 associated with each of the plurality of available stationery 162 are also provided.

The inventory selection interface screen 160 further provides a card interface menu button 168. Selecting the card interface menu button 168 filters the cards to a particular subset of cards, such as those fitting for birthday cards or thank you notes, or any other filtering as desired.

The inventory selection interface screen 160 also provides a general interface menu button 167. Selecting the general interface menu button 167 will enable a drop down menu of functions or other features relating to the user's account and application as a whole, such as logging in or out of the account, billing history, etc.

At this inventory selection interface screen 160, the user then scrolls through each of the plurality of available stationery 162 and the corresponding bitmap photograph previews 164. In the preferred embodiment, the user scrolls through the plurality of available stationery 162 and the corresponding bitmap photograph previews 164 by using their finger, slightly depressing the finger on the card interface screen 160, and dragging their finger upward or downward along the card interface screen 160 to vertically scroll (i.e., top to bottom, or bottom to top) through the plurality of available stationery 162 and the corresponding bitmap photograph previews 164. Alternatively, it is contemplated that the scrolling through the plurality of available stationery 162 and the corresponding bitmap photograph previews 164 may be horizontally across the inventory selection interface screen 160 (i.e., left to right, or right to left), or in any other manner or means that is known to one skilled in the art provided that scrolling is used and operated in the manner to permit scrolling of the plurality of available stationery 162 and the corresponding bitmap photograph previews 164 as described herein.

Upon reviewing the plurality of available stationery 162 and the corresponding bitmap photograph previews 164 and the prices 161 associated with each of the plurality of available stationery 162, if there is no particular stationery 162 from the plurality of available stationery 162 that the user desires and/or desires to exit the system 105, proceed to Step 148. If there is a particular stationery 162 from the plurality of available stationery 162 that the user desires, the user proceeds to select that particular stationery 162. In the same manner as described above, the user selects the particular stationery 162 by using their finger and clicking on the corresponding bitmap photograph preview 164 for the desired stationery 162 within the inventory selection interface screen 160. For the avoidance of doubt and throughout this specification, “clicking”, or “selecting” is accomplished using the finger and engaging or depressing the finger on the desired button within the appropriate interface screen.

Alternatively, it is contemplated that the selection of the stationery 162 from the plurality of available stationery 162 may be accomplished using a selection menu or buttons from the wireless communication device 100, a computer mouse (not illustrated), or in any other manner or means that is known to one skilled in the art.

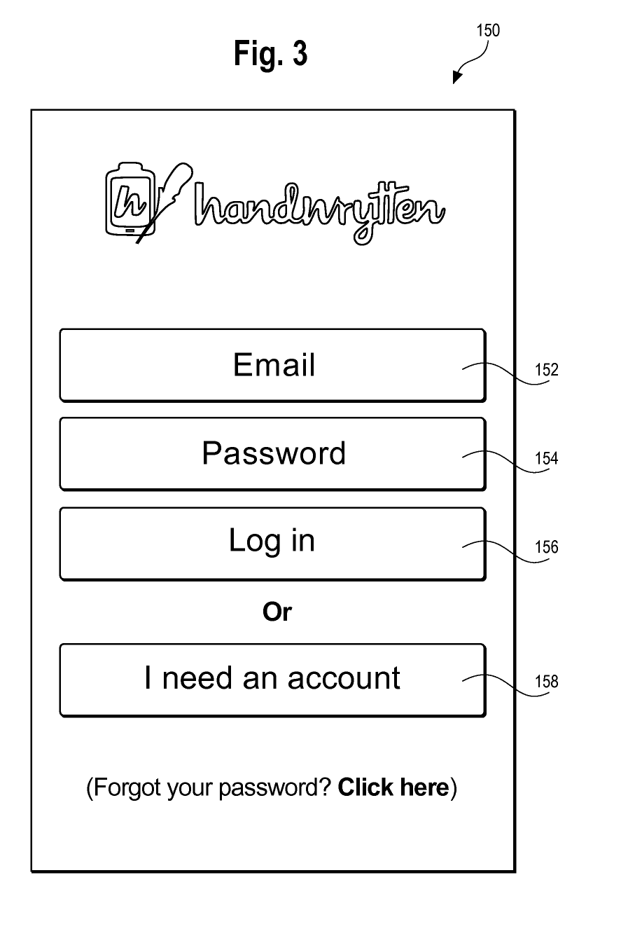

Upon selecting the desired stationery 162 from the plurality of available stationery 162, the system 105 proceeds to a card detail view interface screen 170, as illustrated in FIG. 5. The card detail view interface screen 170 provides the card title 166, the corresponding bitmap photograph preview 164 for the selected stationery 162, a card description 172 for the selected stationery 162, and various views of the selected stationery 162 and a corresponding envelope as available through the views menu bar 174. Also, the card price 182 and a buy button 184 are provided.

The card detail view interface screen 170 also provides a general interface menu button 183. Selecting the general interface menu button 183 will enable a drop down menu of functions or other features relating to the user's account and application as a whole, such as logging in or out of the account, billing history, etc.

In this card detail view interface screen 170, the card title 166 and the corresponding bitmap photograph preview 164 for the selected stationery 162 are displayed in a larger font size to make them more visible to the user. Depending on the selected stationery 162, the views menu bar 174 displays the additional views that are available for the selected stationery 162. In this illustration in FIG. 5, a front view button 176, an inside view button 178, and an envelope view button 180 are available. Upon clicking on or selecting the front view button 176 will display the front view of the selected stationery 162. Upon clicking on or selecting the inside view button 178 will likewise display the view of what the selected stationery 162 looks like on the inside (i.e., whether the inside of the selected stationery 162 is blank or provides any pre-printed written text, indicia, or other designs). And, upon clicking on or selecting the envelope view button 180 will display a view of the corresponding envelope provided for the selected stationery 162.

As the user reviews the above information for the selected stationery 162, the card description 172 provides a more detailed description and/or comments relating to the selected stationery 162 that may be of use or helpful to the user.

Should the user not desire to purchase this selected stationery 162, upon the user clicking on or selecting the back button 186 proceeds back to the inventory selection interface screen 160, as illustrated in FIG. 4, where the user can again review the other of the plurality of available stationery 162 and the corresponding bitmap photograph previews 164 for a desired stationery 162. Alternatively, if the user is not able to choose a particular stationery 162 from the plurality of available stationery 162 that the user desires and/or desires to exit the system 105, proceed to Step 148.

From the card detail view interface screen 170, as illustrated in FIG. 5, should the user desire to purchase the selected stationery 162 (also referred to herein as “selected stationery 162”), upon the user clicking on or selecting the buy button 184, the system 105 proceeds to Step 114.

In Step 114, the user may upload a custom photograph to use instead of or in connection with the selected stationery 162. Upon the user uploading the desired custom photograph, proceed to Step 116.

In Step 116, the system 105 displays a plurality of available handwriting styles 188 (also individually referred to as “handwriting style 188”). In the preferred embodiment, the plurality of available handwriting styles 188 are displayed in varying or different pen types (including but not limited to cursive and block styles) and in varying or different colors available for each pen type. Sample previews of the plurality of available handwriting styles 188 in each of the varying and/or different pen types and available colors is also provided. Upon selecting the desired handwriting style 188 from the plurality of available handwriting styles 188, the system 105 proceeds to Step 118. Alternatively, the plurality of available handwriting styles 188 may be available through a drop down menu as provided by the card composition interface screen 190, identified in Step 118 below.

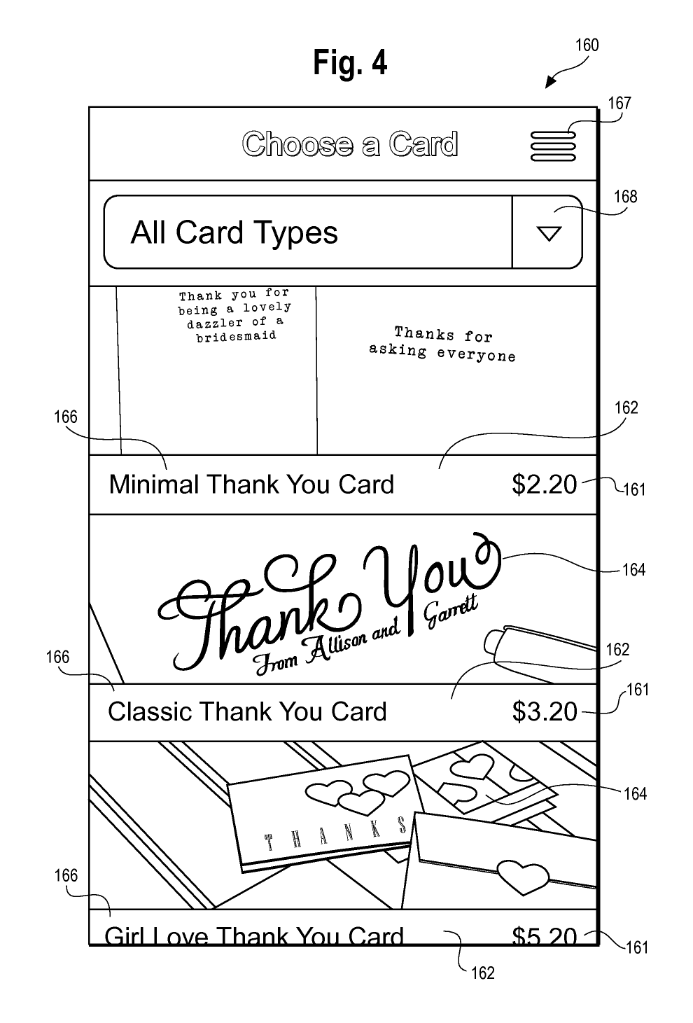

In Step 118, the user enters the written text or other indicia that the user desires to be written on the selected stationery 162 or custom photograph. In this manner, the system 105 displays a card composition interface screen 190, as illustrated in FIG. 6. The card composition interface screen 190 provides the card title 166, the corresponding bitmap photograph preview 164 for the selected stationery 162, the card price 182, a text box 192, and a lines remaining indicator 194. Additionally, a font choice selection drop-down menu may likewise be included in this card composition interface screen 190.

The user then enters written text, indicia, or other designs (collectively referred to herein as “text 198”) into the text box 192. Based on the selected stationery 162 and the handwriting styles 188 selected by the user defines the available space or lines of text 198 that may be received or written on the selected stationery 162. The system 105 tracks the text 198 that is entered by the user into the text box 192 and the lines remaining indicator 194 identifies by number how many additional lines of text 198 that is available for the user to enter for the selected stationery 162. Upon the lines remaining indicator 194 reaching “0”, the system 105 prevents the user from entering any further text 198 into the text box 192. The user may freely enter, revise, delete, and/or add text 198 into the text box 192 until the text 198 is in the form as desired by the user.

The card composition interface screen 190 further provides a general interface menu button 196. Selecting the general interface menu button 196 will enable a drop down menu of functions or other features relating to the user's account and application as a whole, such as logging in or out of the account, billing history, etc.

Should the user not desire to proceed with this selected stationery 162, upon the user clicking on or selecting the back button 186 proceeds back to the card detail view interface screen 170, as illustrated in FIG. 5. Alternatively, if the user is not able to enter the text 198 for the selected stationery 162 that the user desires and/or desires to exit the system 105, proceed to Step 148.

From the card composition interface screen 190, as illustrated in FIG. 6, upon the user entering the desired text 198 for the selected stationery 162 into the text box 192 (also referred to herein as “desired text 202”), and the user clicking on or selecting the send this card button 200, the system 105 proceeds to Step 120.

In Step 120, the user may upload or select a custom signature image to use in connection with the selected stationery 162. Upon the user uploading or selecting the desired custom signature image, proceed to Step 122.

In Step 122, if the user does not have a return and recipient (delivery) address stored in the system 105, proceed to Step 124. If the user is a repeat customer and does have a return and recipient (delivery) address stored in the system 105, proceed to Step 126.

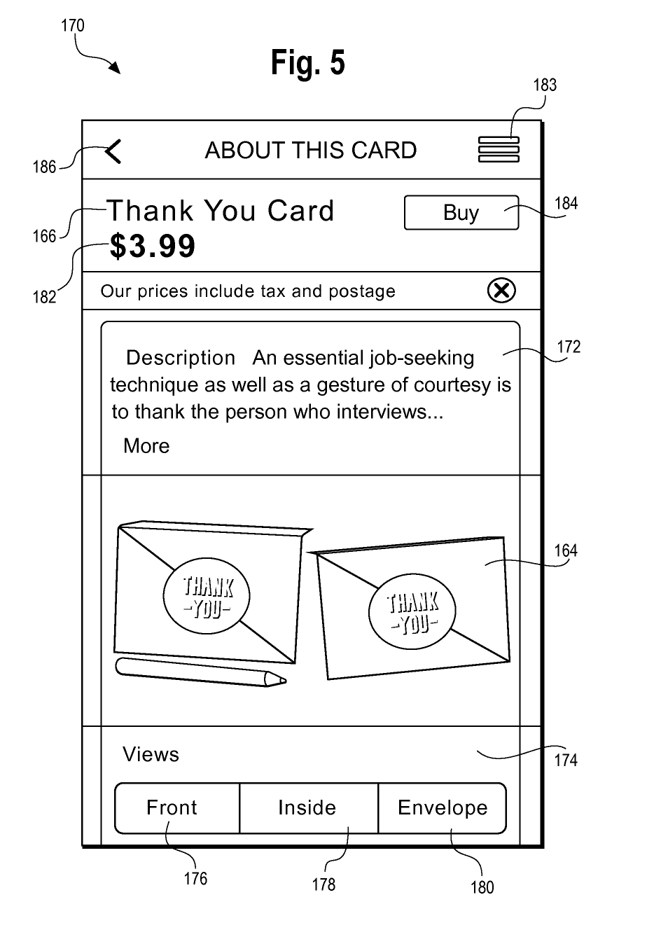

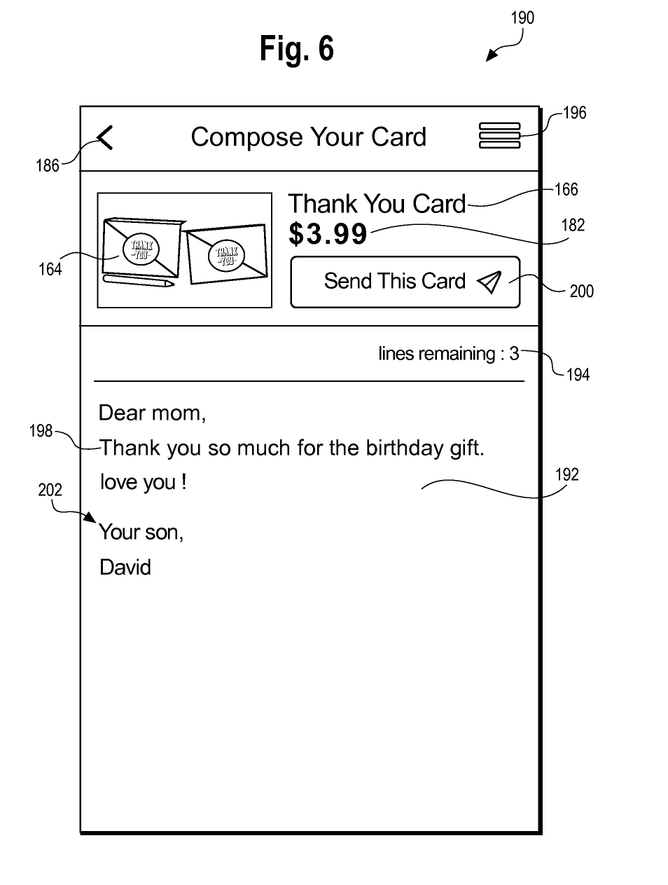

In Step 124, the user enters the return and recipient (delivery) address that is applicable for or desired by the user. In this manner, the system 105 displays an address interface screen 204, as illustrated in FIG. 7. The address interface screen 204 is bifurcated, whereby the top half provides entry of a return address, including a first and last name prompt 206, address line 1 prompt 208, an address line 2 prompt 210, a city prompt 212, a state prompt 214, and a zip code prompt 216. The address interface screen 204 also provides entry of the recipients (delivery) address in the bottom half. The bottom half lists prior recipients of the user (if any) in recipient address display 217, an add new button 218, and a take from phone button 224. If the user has no saved recipients, the recipient address display 217 provides an empty saved recipient box, as shown in FIG. 7. If the user has saved recipients, the address interface screen 228 provides a list of prior recipients, as shown in FIG. 8.

The address interface screen 204 further provides a general interface menu button 226. Selecting the general interface menu button 226 will enable a drop down menu of functions or other features relating to the user's account and application as a whole, such as logging in or out of the account, billing history, etc.

The user then enters the user's first and last name into the first and last name prompt 206; the user's applicable or desired address into the address line 1 prompt 208 and, if additional lines are needed, the remaining applicable or desired address into the address line 2 prompt 210; and the user's city, state, and zip code associated with the applicable or desired address into the city prompt 212, the state prompt 214, and the zip code prompt 216, respectively. Upon the user entering the applicable or desired address into the designated prompts, this is referred to herein as (“desired return address 220”).

Should the user not desire to proceed with entering the desired return address 220 nor selecting or entering a recipient address, upon the user clicking on or selecting the back button 186 proceeds back to the card composition interface screen 190, as illustrated in FIG. 6. Alternatively, if the user is not able to enter the desired return address 220 or recipient address that the user desires and/or desires to exit the system 105, proceed to Step 148.

In Step 122, if the user is a repeat customer and does have a return and recipient (delivery) address stored in the system 105, proceed to Step 126.

In Step 126, the user's return address is prepopulated in the appropriate fields in the desired return address 220, as illustrated in FIG. 8. The user then confirms the information in the appropriate fields in the desired return address 220, updating these fields as appropriate.

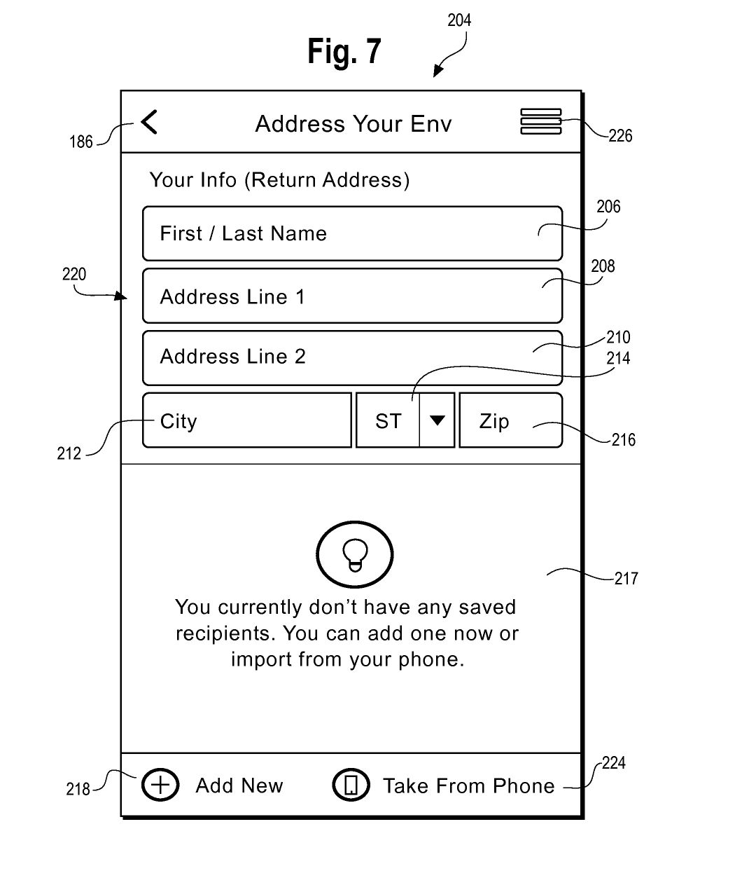

As illustrated in FIG. 8, if the user desires to send the selected stationery 162 to an existing recipient, upon reviewing the existing recipient names 230, 232, 234, and corresponding existing recipient addresses 236, 238, 240, if there is a particular existing recipient name 242 and existing recipient (delivery) address 244 from the plurality of existing recipient names 230, 232, 234, etc. and corresponding existing recipient addresses 236, 238, 240, etc. that provides the recipient (delivery) address that the user desires to use for the desired recipient, the user proceeds to select that particular existing recipient name 242 and existing recipient address 244. The user selects the particular existing recipient name 242 and existing recipient address 244 by using their finger and clicking on the corresponding existing recipient name 242 and existing recipient address 244 within the existing address interface screen 228. In this manner, the system 105 then populates the selected recipient (delivery) address into a first and last name prompt 250, an address line 1 prompt 252, an address line 2 prompt 254, a city prompt 256, a state prompt 258, and a zip code prompt 260, as illustrated in FIG. 9.

Upon reviewing the existing recipient names 230, 232, 234, and corresponding existing recipient addresses 236, 238, 240, if there is no particular existing recipient name 242 and existing recipient address 244 from the plurality of existing recipient names 230, 232, 234, etc . . . and corresponding existing recipient addresses 236, 238, 240, etc . . . that provide the recipient (delivery) address that the user desires to use for the desired recipient address, the user may then proceed to manually enter the desired recipient address into the first and last name prompt 250, the address line 1 prompt 252, the address line 2 prompt 254, the city prompt 256, the state prompt 258, and the zip code prompt 260, in the same manner as described above in Step 124 with respect to the address interface screen 204, as illustrated in FIG. 7.

Alternatively, in lieu of the user having to either select from the existing recipient names 230, 232, 234, and corresponding existing recipient addresses 236, 238, 240 and/or manually enter the desired recipient address 264 into the designated prompts, the user may obtain this recipient (delivery) address information from its wireless communication device 100. As illustrated in FIG. 7 or 8, upon the user clicking on or selecting the take from phone button 224 on the address interface screen 204, the system 105 enters and displays all of the contacts stored in the wireless communication device 100 in a contacts interface screen (not illustrated). In the preferred embodiment, the user then scrolls through each of the available contacts displayed in the contacts interface screen by using their finger, slightly depressing the finger on the contacts interface screen and dragging their finger upward or downward along the contacts interface screen to vertically scroll (i.e., top to bottom, or bottom to top) through the plurality of available contacts. Alternatively, it is contemplated that the scrolling through the plurality of available contacts may be horizontally across the contacts interface screen (i.e., left to right, or right to left), or in any other manner or means that is known to one skilled in the art provided that scrolling is used and operated in the manner to permit scrolling of the plurality of available contacts as described herein.

Upon reviewing the plurality of available contacts, if there is no particular contact from the plurality of available contacts that provide the recipient (delivery) address that the user desires to use for the desired recipient (delivery) address 264 (see FIG. 9), the user may then proceed back to manually enter the desired recipient address 264 in the address interface screen 204, as described above. If there is a particular contact from the plurality of available contacts that provides the recipient (delivery) address that the user desires, the user proceeds to select that particular contact and recipient address. In the same manner as described above, the user selects the particular contact by using their finger and clicking on the corresponding contact within the contact interface screen. In this manner, the system 105 populates the recipient (delivery) address into the first and last name prompt 250, the address line 1 prompt 252, the address line 2 prompt 254, the city prompt 256, the state prompt 258, and the zip code prompt 260, in the same manner as described above with respect to the address interface screen 204, as illustrated in FIG. 9.

In another alternative, in lieu of the user having to either select from the existing recipient names 230, 232, 234, and corresponding existing recipient addresses 236, 238, 240, and/or obtain the recipient (delivery) address information from the wireless communication device 100 using the take from phone button 224, upon the user then clicking on or selecting the add new button 218, as illustrated in FIGS. 7 and 8, the system 105 proceeds to the address interface screen 204, as illustrated in FIG. 9, to permit the user to enter the recipient (delivery) address that is applicable for or desired by the user. The user then enters the recipient's first and last name into the delivery first and last name prompt 250; the recipient's applicable or desired address into the delivery address line 1 prompt 252 and, if additional lines are needed, the remaining applicable or desired recipient's address into the delivery address line 2 prompt 254; and the recipient's city, state, and zip code associated with the applicable or desired recipient delivery address into the delivery city prompt 256, the delivery state prompt 258, and the delivery zip code prompt 260, respectively. After the recipient address is populated or entered into the applicable or desired address into the designated prompts from the manual entry, proceed to Step 128.

In Step 128, the system 105 sends or transmits the selected stationery 162, the custom photograph (if provided), the handwriting style 188 including selected pen type and color, the custom signature image, the desired text 202, the desired return address 220, and the desired delivery address 264 (collectively referred to herein as “order information”) to the web/application server 102, and then proceeds to Step 130.

In Step 130, the system 105 stores the order information on the web/application server 102 and, based on the order information, calculates the total price (“total price”) for the order (“desired order”). In the preferred embodiment, the total price is calculated as the card price 182, as illustrated in the card detail view interface screen 170 in FIG. 5 and the card composition interface screen 190 in FIG. 6, which includes applicable tax and postage and any other required fees or other fees associated with the desired order. Then, proceed to Step 132.

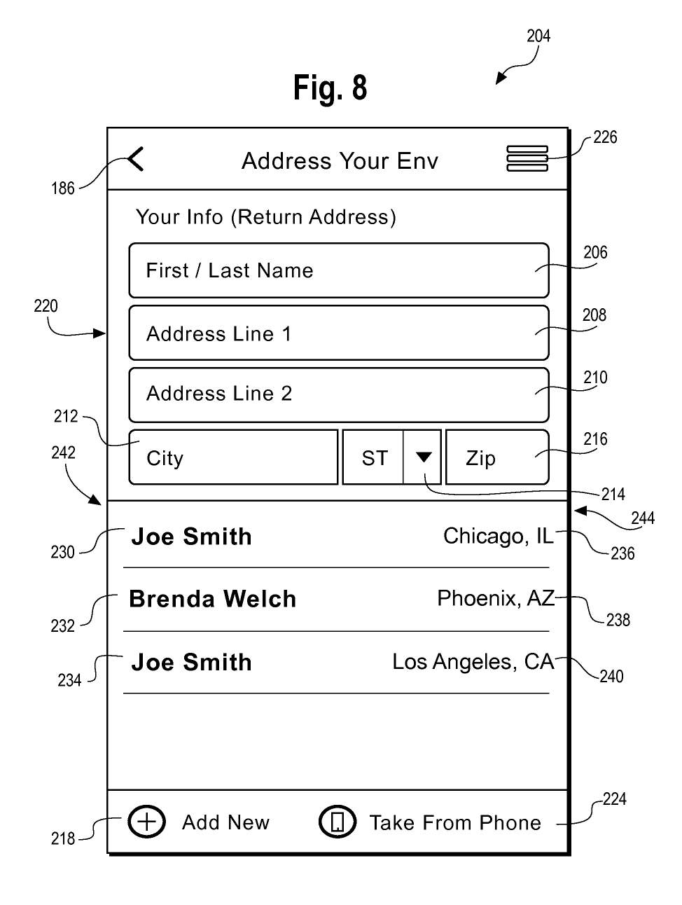

In Step 132, the user confirms the total price for the desired order and then proceeds to process payment for the desired order. In this manner, for users that do not have a credit card or other payment information stored in the system 105, the system 105 displays a billing information interface screen 268, as illustrated in FIG. 10. The billing information interface screen 268 provides a total price confirmation 270, a scan my card button 272, and an add new card button 274.

The billing information interface screen 268 further provides a general interface menu button 276. Selecting the general interface menu button 276 will enable a drop down menu of functions or other features relating to the user's account and application as a whole, such as logging in or out of the account, billing history, etc.

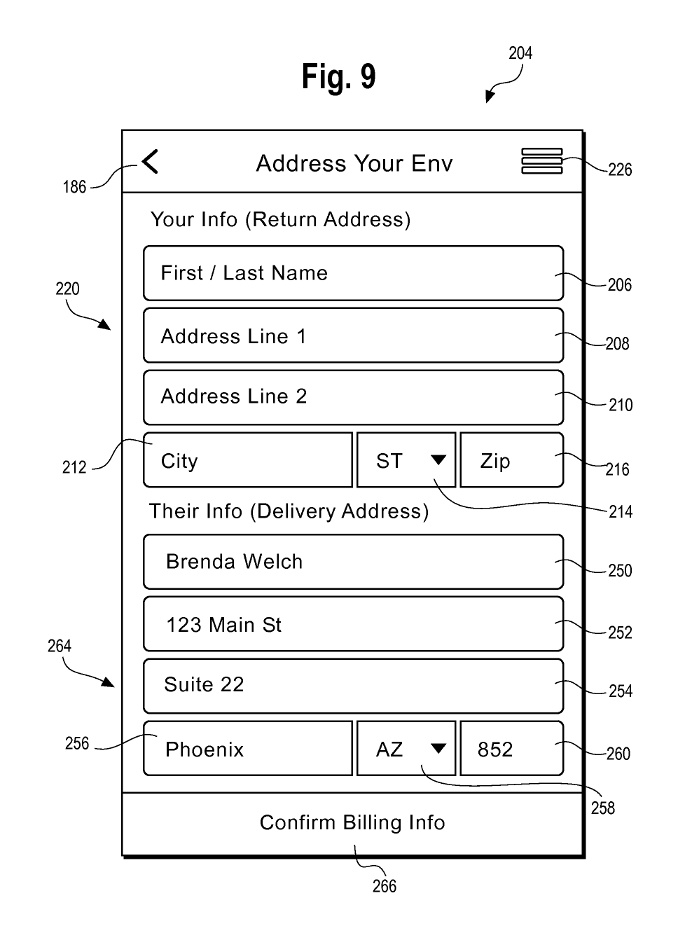

Upon review, the user is able to confirm the total price for the desired order from the total price confirmation 270. If the total price confirmation 270 is acceptable to the user, the user then proceeds to process payment for the desired order using either the scan my card button 272 or add new card button 274. Upon the user clicking on or selecting the scan my card button 272 and the user having the credit card available, the wireless communication device 100, using a scan.io or other similar framework known to one skilled in the art, scans a photograph of the front and, if necessary, the back of the credit card and then proceeds to the completed billing information interface screen 278, as illustrated in FIG. 11.

Alternatively, if the user does not have the physical credit card available or for any reason the wireless communication device 100 is unable to scan a photograph of the credit card, upon clicking on or selecting the add new card button 274, proceeds to allow the user to manually enter all of the appropriate credit card information (“desired credit card information”). Upon the user entering all of the appropriate desired credit card information into the system 105, the system 105 proceeds to the completed billing information interface screen 278, as illustrated in FIG. 11.

Should the user not desire to proceed with the desired order due to the total price as shown in the total price confirmation 270 not being acceptable or for any other reason, upon the user clicking on or selecting the back button 186 proceeds back to the delivery address interface screen 248, as illustrated in FIG. 9, and if the user continues clicking on or selecting the back button 186 enables the user to proceed to the any of the previous interface screens, as desired. Alternatively, if the user desires to exit the system 105, proceed to Step 148.

In Step 132, for users that are repeat customers and/or users that do have a credit card or other payment information stored in the system 105, proceed to the completed billing information interface screen 278, as illustrated in FIG. 11. The completed billing information interface screen 278 provides a desired credit card button 280, an update credit card button 282, a delete credit card button 284, a scan new credit card button 286, an add new credit card button 288, and a send payment now button 290.

The completed billing information interface screen 278 further provides a general interface menu button 292. Selecting the general interface menu button 292 will enable a drop down menu of functions or other features relating to the user's account and application as a whole, such as logging in or out of the account, billing history, etc.

The desired credit card button 280 provides an identifying description 294 relating to the credit card or other payment information stored in the system 105 or the manually entered desired credit card information from the billing information interface screen 268, as illustrated in FIG. 10. Preferably, the identifying description 294 identifies the type of credit card and the last four digits of the credit card. For example, in a non-limiting example, the identifying description 294 may state “My Mastercard ending in 8842.” Alternatively, any other descriptive or other identifying methods or formats may be used for the identifying description 294 as is known to one skilled in the art.

If, upon review by the user, the identifying description 294 of the credit card is inaccurate, not the correct credit card, or for any other reason is not the desired credit card, the user may then proceed to:

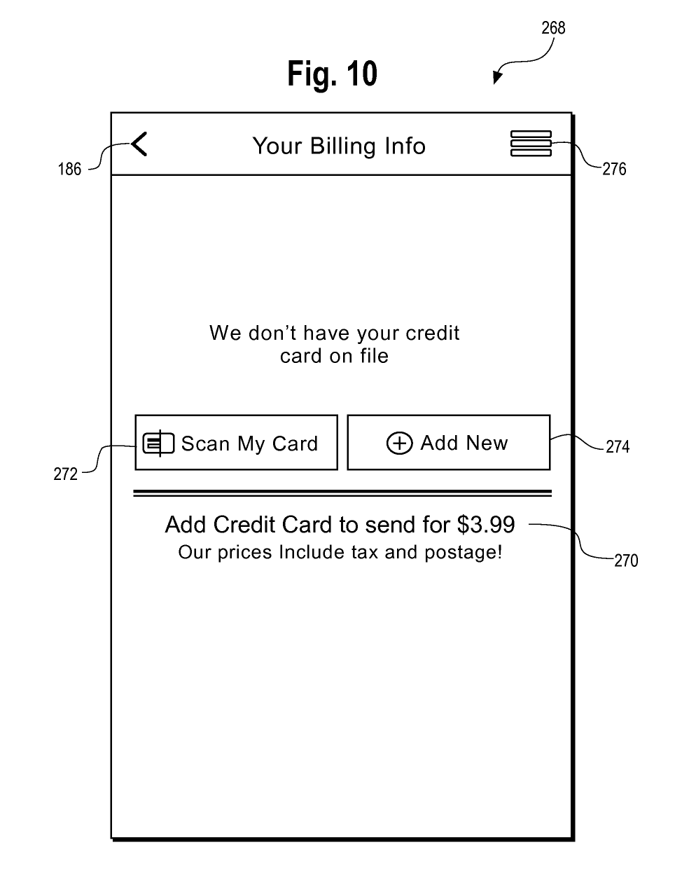

(a) update the credit card. Upon the user clicking on or selecting the update credit card button 282, the user may appropriately update the credit card to the desired credit card (“updated desired credit card”) through the update desired credit card interface screen 298, as illustrated in FIG. 12. The update desired credit card interface screen 298 provides a type of credit card prompt 300, a type of credit card interface menu button 302 that enables a drop down menu of selections of the types of a credit card available to enter into the type of credit card prompt 300, a credit card number prompt 304, an expiration date month prompt 306, an expiration date year prompt 308, a credit card verification value prompt 310, a name on credit card prompt 312, an address line 1 for credit card prompt 314, an address line 2 for credit card prompt 316, a city for credit card prompt 318, a state for credit card prompt 320, and a zip code for credit card prompt 322. The user then enters the appropriate information into each of these above prompts. The update desired credit card interface screen 298 further provides an update desired credit card interface menu button 330. Selecting the update desired credit card interface menu button 330 will enable a drop down menu of functions or other features relating to updating the desired credit card. Should the user desire to delete the information entered into the above prompts and re-enter the appropriate information, upon clicking on or selecting the delete credit card information prompt 326 will reset all of the above prompts to blank so that the user can re-enter the appropriate desired credit card information. Upon completion of the user entering the appropriate information into each of these above prompts and clicking on or selecting the update credit card button 328, the desired credit card is updated and the identifying description 294 is likewise updated to reflect the updated desired credit card. The system 105 then proceeds back to the completed billing information interface screen 278, as illustrated in FIG. 11. Similarly, should the user desire to cancel this part of the process and retain the desired credit card information in the system 105, upon clicking on or selecting the cancel update desired credit card button 324, proceeds back to the completed billing information interface screen 278, as illustrated in FIG. 11;

(b) delete the credit card. Upon the user clicking on or selecting the delete credit card button 284, the user may appropriately delete the credit card from the system 105 (“deleted desired credit card”);

(c) scan a new credit card. Upon the user clicking on or selecting the scan new credit card button 286 and the user having the credit card available, the wireless communication device 100, using a scan.io or other similar framework known to one skilled in the art, scans a photograph of the front and the back of the credit card and then proceeds to enter the scanned new desired credit card into the system 105 (“scanned new desired credit card”). Upon completion, the identifying description 294 shall likewise be updated to reflect the scanned new desired credit card; or

(d) add a new credit card. Upon the user clicking on or selecting the add new credit card button 288, the user may appropriately add a new credit card into the system 105 as the added new desired credit card (“added new desired credit card”). Upon completion, the identifying description 294 shall likewise be updated to reflect the added new desired credit card.

Collectively, the updated desired credit card, the scanned new desired credit card, and the added new desired credit card are all also referred to as the “desired billing credit card.”

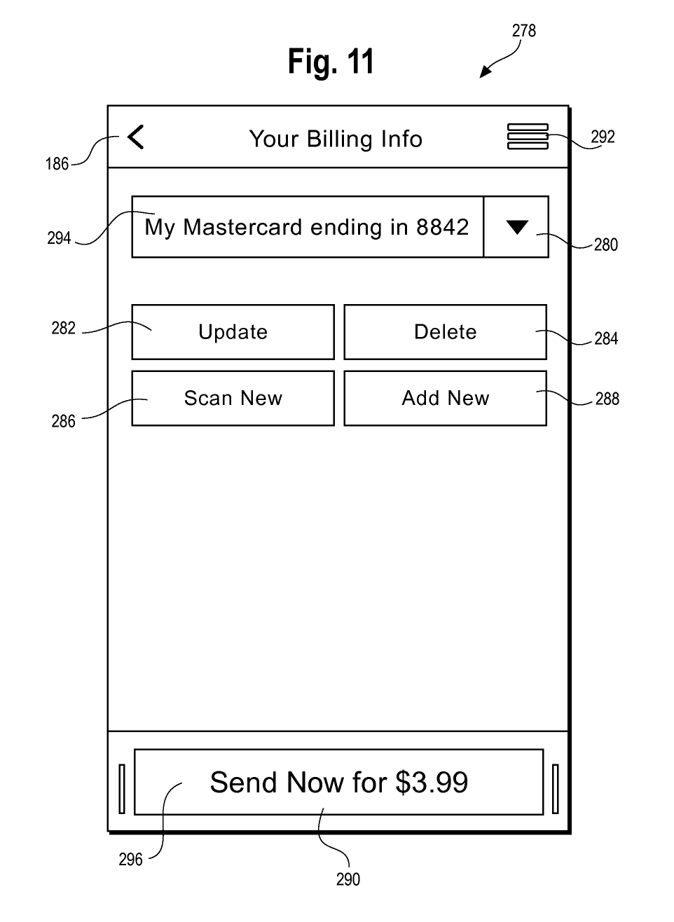

Upon completion and entry of the desired billing credit card, the user may then proceed to process payment for the desired order through the completed billing information interface screen 278, as illustrated in FIG. 11. The send payment now button 290 re-displays the total price for the desired order in a billing payment description 296. Preferably, the billing payment description 296 re-displays the total price for the desired order. For example, in a non-limiting example, the billing payment description 296 may state “Send Now for $3.99.” Alternatively, any other descriptive or other identifying methods or formats may be used for the billing payment description 296 as is known to one skilled in the art. Upon the user clicking on or selecting the send payment now button 290, the system 105 processes payment for the desired order using the desired billing credit card (“purchased order”), and proceeds to an order confirmation interface screen 332, as illustrated in FIG. 13.

Should the user not desire to proceed with the desired order for any reason, upon the user clicking on or selecting the back button 186 proceeds back to the billing information interface screen 268, as illustrated in FIG. 10, and if the user continues clicking on or selecting the back button 186 enables the user to proceed to the any of the previous interface screens, as desired. Alternatively, if the user desires to exit the system 105, proceed to Step 148.

The order confirmation interface screen 332 provides a written confirmation description 334 and written confirmation indicia 336 relating to the purchased order. Preferably, the written confirmation description 334 provides a response to the user. For example, in a non-limiting example, the written confirmation description 334 may state “ON ITS WAY! Our robots are hard at work Handwryting your card. It will be stamped and mailed by the next business day and we will email you when it's done!” Alternatively, any other descriptive or other identifying methods or formats may be used for the written confirmation description 334 as is known to one skilled in the art. An acknowledgement button 338 is provided. Upon clicking on or selecting the acknowledgement button 338, proceed to Step 134.

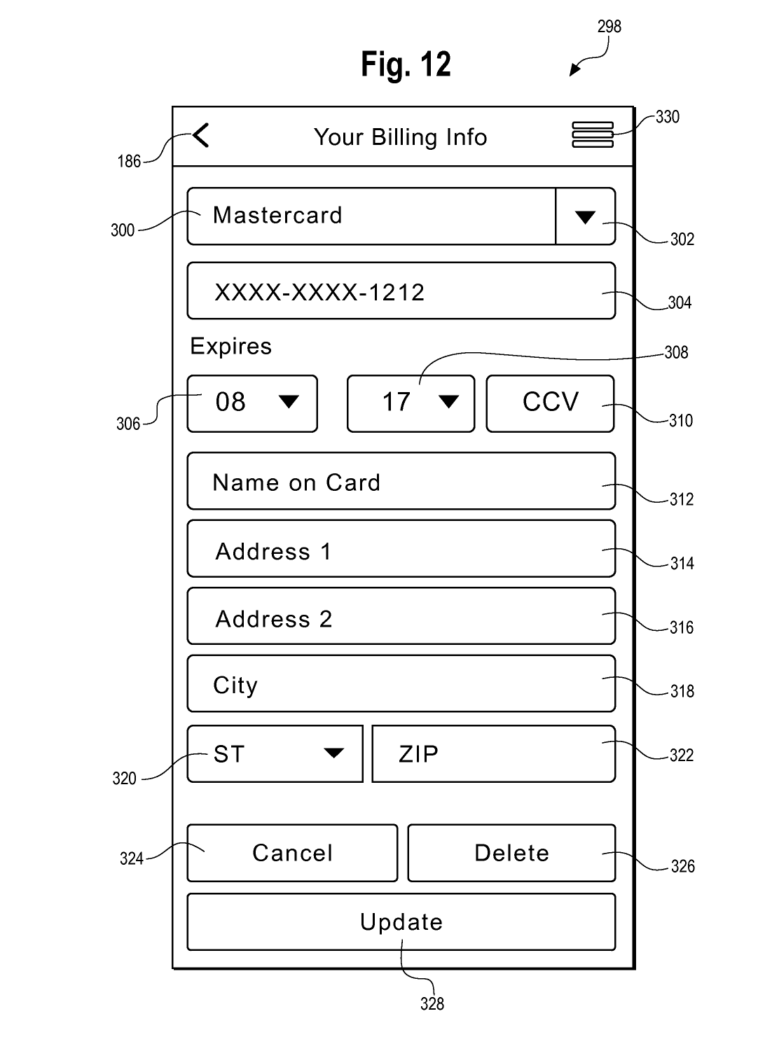

In Step 134, the purchased order is placed in queue for processing, as illustrated in the work order queue interface screen 340, as illustrated in FIG. 14. The work order queue interface screen 340 comprises a work order menu bar 342 which provides access to all of the options of the work order queue interface screen 340.

The work order menu bar 342 provides a users heading 344, a work orders heading 346, a cards heading 348, an admin heading 350, and a log out heading 352. A work orders pane 354 is also displayed which identifies each of the purchase orders from each of the users that is in the processing queue (“work orders”). In the preferred embodiment, the work orders pane 354 provides an identification column 356, a purchased order date column 358, a username column 360, a card identification number column 362, and a card name column 364. For example, in a non-limiting example, the work orders pane 354 identifies an identification number 366 of “5” in the identification number column 356, a purchase order date of “2014-02-01 12:39” in the purchased order date column 358 which represents a purchase order date of Feb. 1, 2014 at 12:39 pm in the afternoon, an email address 370 of “ASmith@email.com” in the email column 360 which represents the user, a card identification number 372 of “123” in the card identification number column 362 which represents the identification number assigned to the purchased order, and a card name 374 of “Simple Thank You” in the card name column 364 which represents the card title 166 for the selected stationery 162.

If the total number of work orders displayed exceed the total number available to be displayed in the work orders pane 354, a work orders pane scroll bar 376 is displayed which provides a work order pane forward button 378 to advance to the next page of work orders displayed in the works orders pane 354 and a work order pane back button 380 to return to the preceding page of work orders displayed in the works orders pane 354.

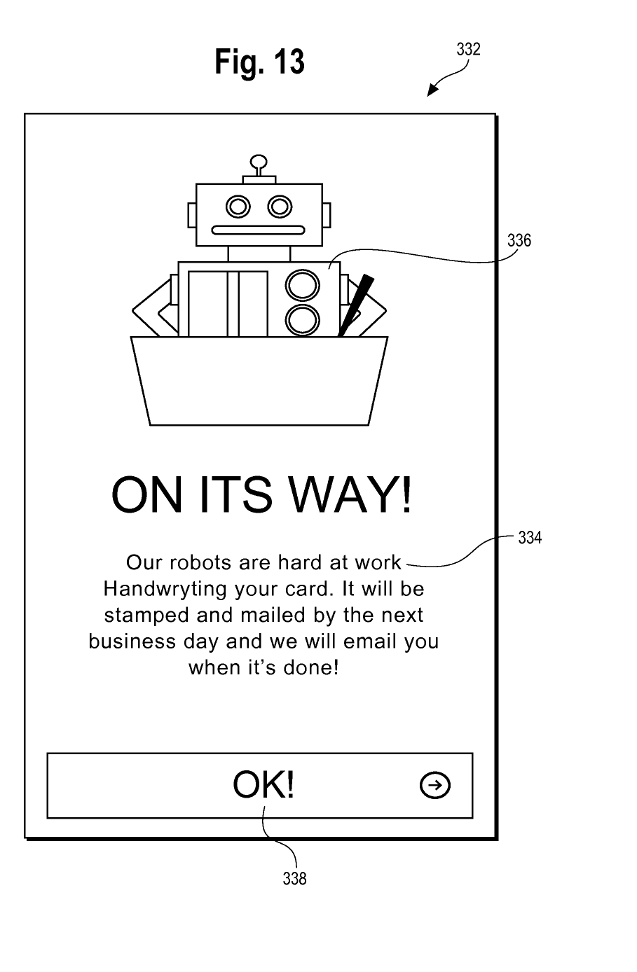

To continue with processing a work order, upon clicking on or selecting the identification number 366, proceed to the view work orders interface screen 382, as illustrated in FIG. 15. The work orders interface screen 382 displays the same work order menu bar 342 providing the users heading 344, the work orders heading 346, the cards heading 348, the admin heading 350, and the log out heading 352 as displayed in the work orders queue interface screen 340, as illustrated in FIG. 14. A back to list of orders button 392, a work order mark as complete button 390, and a cancel work order button 394 are also provided.

In the preferred embodiment, and using the same non-limiting example and upon clicking on or selecting the identification number 366 of “5” in the work orders queue interface screen 340, as illustrated in FIG. 14, this specific work order is displayed in the view work orders interface screen 382, as illustrated in FIG. 15. The view work orders interface screen 382 then displays, for this specific work order, the identification number 366 of “5”, the email address 370 of “ASmith@email.com”, and the card identification number 372 of “123.”

The work orders interface screen 382 also displays or is populated with the desired return address 220 of the first and last name, the address line 1, the address line 2, the city, the state, and the zip code into the work order from pane 384. Likewise, the work orders interface screen 382 also displays or is populated with the desired recipient delivery address 264 of the first and last name, the address line 1, the address line 2, the city, the state, and the zip code into work order to pane 386.

Additionally, the work orders interface screen 382 also displays or is populated with the desired text 202 into the work order card message pane 388. In the preferred embodiment, and using the non-limiting example as illustrated in FIG. 6, the work order card message pane 388 displays, for this specific work order, the desired text 202 of:

“Dear mom,

Thank you so much for the birthday gift.

Love you!

Your son,

David”

Should there be no further desire to proceed with this specific work order, upon clicking on or selecting the back to list of orders button 392 proceeds back to the work order queue interface screen 340, as illustrated in FIG. 14. Alternatively, while in this view work orders interface screen 382, should instructions be received from the user to cancel this work order from the system 105 or a desire to exit the system 105, upon clicking on or selecting the cancel work order button 394, proceed to Step 148.

Upon reviewing the work orders interface screen 382 and to continue with processing the work order, proceed to Step 136.

In Step 136, the desired text 202, the desired return address 220 from the work order to pane 386, the desired delivery address 264 from the work order to pane 386, and desired handwriting style 188 (collectively referred to herein as “work order card printing details”) for this specific work order is transferred or copied from the work order card message pane 388 and inputted or entered into the writing machine 104. In the preferred embodiment, the writing machine 104 provides acceptable software to receive the inputted or entered work order card printing details. Upon successfully and accurately inputting or entering the work order card printing details into the writing machine 104, proceed to Step 138.

In Step 138, the desired text 202, the desired return address 220, and the desired delivery address 264 are converted by the writing machine 104 into the desired handwriting style 188 (each individually referred to as “converted text”, “converted return address”, and “converted delivery address”). Upon successfully and accurately converting this information into the desired handwriting style 188, proceed to Step 140.

In Step 140, if a custom photograph was uploaded by the user in Step 114 to use instead of or in connection with the selected stationery 162, this uploaded desired custom photograph is printed from the computer 103 to the printer 107 onto a postcard cardstock. Upon successfully and accurately printing the uploaded desired custom photograph onto the postcard cardstock, proceed to Step 142.

In Step 142, the selected stationery 162 and/or custom photograph onto the postcard cardstock (referred to herein as the “selected paper”), envelope, and pen for use in printing on the selected paper and envelope is manually loaded into the writing machine 104. Upon successfully and accurately loading the selected paper and pen into the writing machine 104, proceed to Step 144.

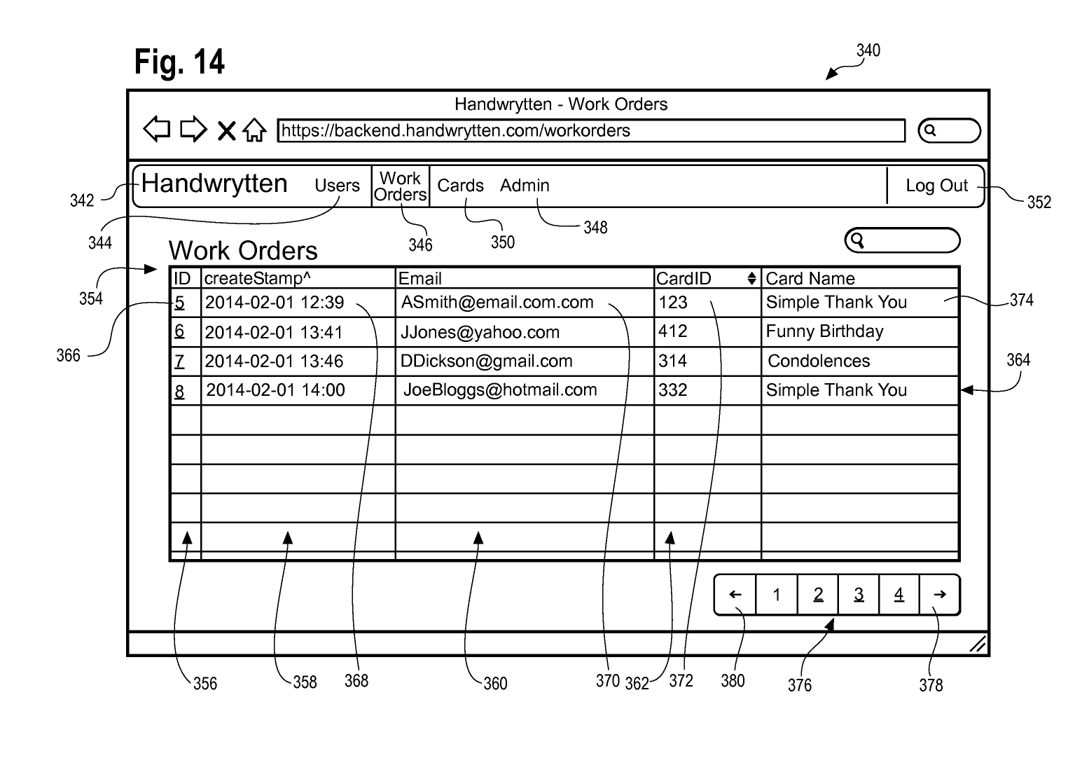

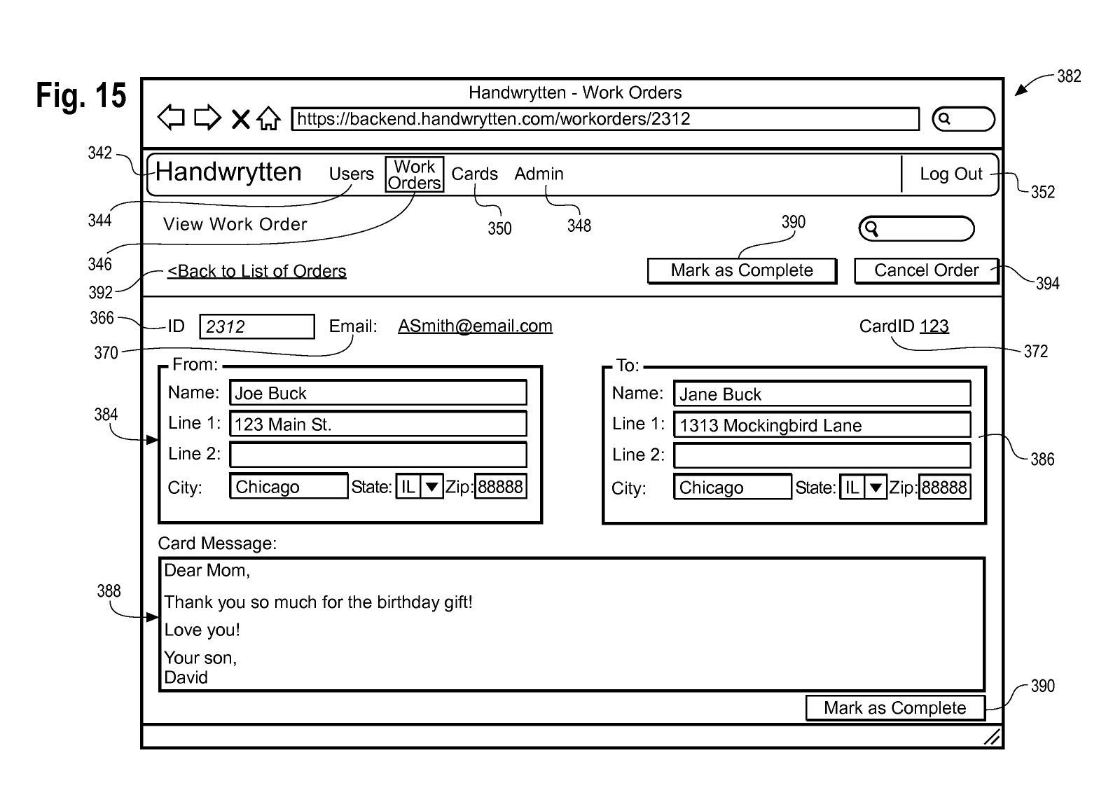

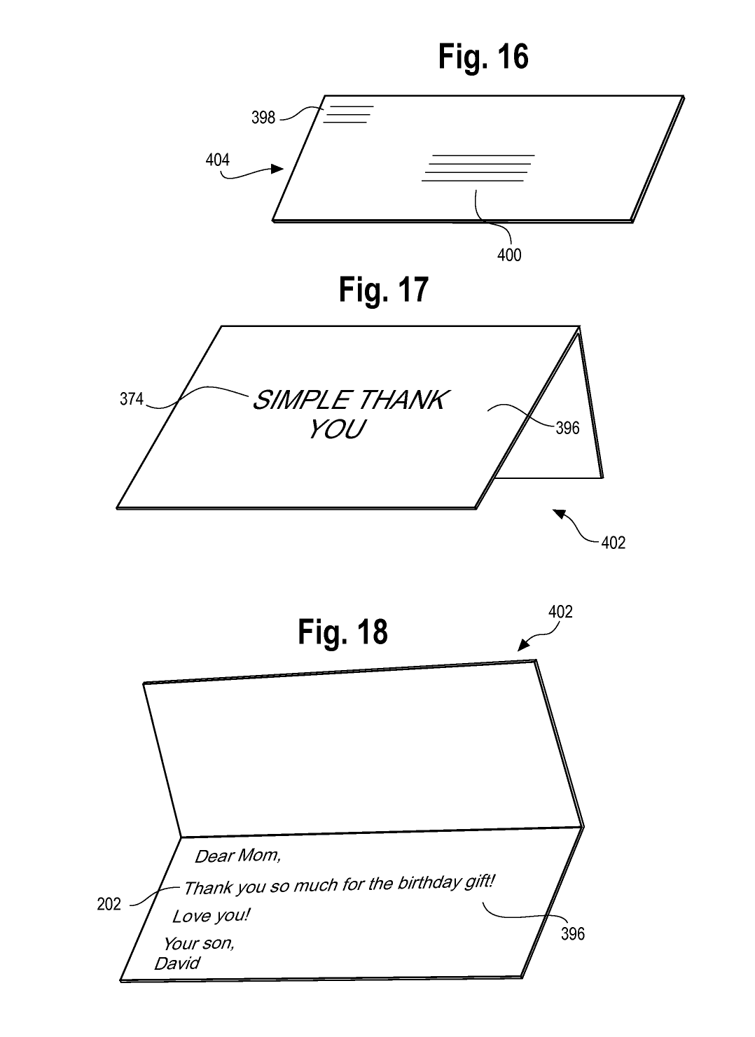

In Step 144, the writing machine 104 transcribes or writes the converted text 396 (which includes the desired text 202 and card name 374), the converted return address 398, and the converted delivery address 400 to the selected paper for the printed card 402 and envelope 404 (“printed card and envelope”). In the preferred embodiment, the completed printed card and envelope is illustrated in FIGS. 16, 17, and 18. Upon successfully and accurately transcribing or printing the printed card and envelope, proceed to Step 146.

In Step 146, the work order is marked as printed and completed. Returning back to the view work orders interface screen 382, as illustrated in FIG. 15, upon clicking on or selecting the work order mark as complete button 390 identifies this specific work order as complete and simultaneously sends an electronic e-mail to the wireless communication device 100 of the user notifying the user of the completed processing of the purchase order. Upon the work order and/or purchase order being marked as complete and notification sent to the user, proceed to Step 148.

In Step 148, the operation of a unique method for wirelessly generating simulated handwritten correspondence ends.

Thus, there has been provided a unique method and apparatus for generating simulated handwritten correspondence. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the invention and the appended claims.

What is claimed is:

1. A computer based method for generating a handwritten correspondence, comprising the steps of:
providing at least one description of at least one available stationery;
providing a price for the at least one available stationery;
selecting the at least one available stationery and defining a selected stationery;
displaying at least one available handwriting style to use on the selected stationery;
selecting the at least one available handwriting style and defining the handwriting style;
entering the written text to use on the selected stationery;
defining the selected stationery, the handwriting style, and the written text as the order;
transferring the handwriting style and the written text from the computer device to a writing machine; and
transcribing the written text in the handwriting style on the selected stationery and defining a completed correspondence.

2. The method of claim 1 and further comprising the step of logging a user into a mobile application device.

3. The method of claim 1 and further comprising the step of providing at least one visual image of the at least one available stationery.

4. The method of claim 1 and further comprising the step of displaying the selected stationery in a larger size for easier viewing.

5. The method of claim 1 and further comprising the step of providing a plurality of selections to view the selected stationery and an envelope, the plurality of selections consisting of the front view of the selected stationery, the inside view of the selected stationery, and the view of the envelope.

6. The method of claim 1 and further comprising the step of uploading a photograph to use on the selected stationery and defining an uploaded photograph.

7. The method of claim 1 and further comprising the step of providing at least one pen type for the at least one available handwriting style.

8. The method of claim 1 and further comprising the step of providing at least one color for the at least one available handwriting style.

9. The method of claim 1 and further comprising the step of entering indicia to use on the selected stationery.

10. The method of claim 5 and further comprising the step of entering a return address to use on the envelope for the selected stationery.

11. The method of claim 10 and further comprising the step of entering a delivery address to use on the envelope for the selected stationery.

12. The method of claim 1 and further comprising the step of transferring the order from the computer device to a second computer device.

13. The method of claim 12 and further comprising the step of calculating a total price for the order.

14. The method of claim 13 and further comprising the step of paying the total price for the order.

15. The method of claim 14 and further comprising the step of providing a written receipt confirming payment of the total price for the order.

16. The method of claim 6 and further comprising the step of transferring the uploaded photograph from the second computer device to a printer.

17. The method of claim 16 and further comprising the step of printing the uploaded photograph to the selected stationery.

18. The method of claim 11 and further comprising the step of transferring the return address and the delivery address from the computer device to the writing machine.

19. The method of claim 18 and further comprising the step of printing the return address and the delivery address on the envelope for the selected stationery and defining a completed envelope.

20. The method of claim 19 and further comprising the step of sending the completed envelope to the user.

21. The method of claim 1 and further comprising the step of sending the completed correspondence to the user.

22. The method of claim 21 and further comprising the step of sending a written notification confirming completion of the order to the user.

23. A method for generating a correspondence, comprising the steps of:
if a user is logged into a computer device, then performing the following steps (a)-(b):
(a) providing a plurality of descriptions, each of the plurality of descriptions corresponding to at least one of a plurality of available stationery;
(b) providing a price for each of the plurality of available stationery;
if the user desires to proceed with one of a plurality of available stationery, then performing the following steps (c)-(g):
(c) selecting a stationery from the plurality of available stationery and defining a selected stationery;
(d) displaying a plurality of available handwriting styles to use on the selected stationery;
(e) selecting a handwriting style from the plurality of available handwriting styles and defining the handwriting style;
(f) entering the written text to use on the selected stationery;
(g) defining the selected stationery, the handwriting style, and the written text as the order;
if the order is defined, then performing the following steps (h)-(i):
(h) transferring the handwriting style and the written text from the computer device to a writing machine; and
(i) printing the written text in the handwriting style on the selected stationery and defining a completed correspondence.

24. The method of claim 23 and further comprising the step of if the order is to be paid, then performing the following steps (j)-(k):
(j) calculating a total price for the order; and
(k) paying the total price for the order.

25. The method of claim 23 and further comprising the step of if the handwriting style is selected, then performing the following steps (j)-(l):
(j) providing a plurality of pen types for the handwriting style;
(k) providing a plurality of colors for the handwriting style; and
(l) selecting a pen type and a color for the handwriting style.

26. The method of claim 23 and further comprising the step of if the user desires to proceed with one of a plurality of available stationery, then performing the following steps (j)-(k):
(j) entering a return address to use on an envelope for the selected stationery; and
(k) entering a delivery address to use on the envelope for the selected stationery.

27. The method of claim 26 and further comprising the step of if the order is defined, then performing the following steps (l)-(m):
(l) transferring the return address and the delivery address from the computer device to the writing machine; and
(m) printing the return address and the delivery address on the envelope for the selected stationery and defining a completed envelope.

28. The method of claim 23 and further comprising the step of if the order is defined, then performing the following steps (j)-(k):
(j) sending the completed envelope to the user; and
(k) sending the completed correspondence to the user.
